(19) United States
(12) Patent Application Publication
(10) Pub. No.: US 2013/0030869 A1
(43) Pub. Date: Jan. 31, 2013

(54) METHODS OF TREATING SUBTERRANEAN FORMATIONS

(71) Applicants: Luke D. Costesso, Sugar Land, TX (US); Vincent M. DeBonis, Sugar Land, TX (US); Juan Pablo Roca, Elk City, OK (US); Muqsit Ashraf, Sugar Land, TX (US)

(72) Inventors: Luke D. Costesso, Sugar Land, TX (US); Vincent M. DeBonis, Sugar Land, TX (US); Juan Pablo Roca, Elk City, OK (US); Muqsit Ashraf, Sugar Land, TX (US)

(21) Appl. No.: 13/192,540

(22) Filed: Jul. 28, 2011

(51) Int. Cl. G06Q 30/00

(52) U.S. Cl. 705/7.35

(57) ABSTRACT

The method comprises determining an internal factor of the oilfield operation representing a cost analysis of an oilfield service; determining an external factor of the oilfield operation representing a price analysis and/or a market analysis of the oilfield service; determining a price of the oilfield operation to be performed in the well for a customer, wherein the price is determined based on the internal factor and the external factor, and wherein determining the price comprises utilizing a data processing system; transmitting the price of the oilfield operation to the customer; completing a sale of the oilfield operation; and performing the oilfield operation in the well.

### FIELD OF THE INVENTION

The invention relates to determining, pricing and/or providing oilfield services treatments. More particularly, the present invention relates to internal factors and external factors methodologies for determining, pricing, and/or providing oilfield servicing treatments therefore.

### BACKGROUND

The statements in this section merely provide background information related to the present disclosure and may not constitute prior art.

Oilfield services in general or well servicing treatments include a wide variety of subterranean operations that may be performed in oil, gas, geothermal, CO₂ and/or water wells, such as wireline, drilling, completion, and workover operations. The drilling, completion, and workover operations may include, but are not limited to, drilling, fracturing, acidizing, logging, coil tubing, cementing, gravel packing, perforating, and conformance operations.

The oilfield service companies providing well servicing treatments operate in a competitive environment. The oilfield service companies desire to be cost-effective in this competitive market. Therefore, they want to determine the accurate price of their respective well servicing treatments. Conventionally, the price for well servicing treatments is determined based on the particular well servicing treatment to be performed. Those well servicing treatments are priced based on the component cost of the treatment fluid and may include pricing for chemicals, tools, labor, and/or equipment involved in the well servicing treatment.

For instance, in a fracturing operation, an optimal fracturing fluid for the operation may first be determined using past well data or characteristics about the field. Next, the price of the fracturing fluid may be determined based on the component cost of the optimal fracturing fluid, the total amount of the fracturing fluid needed for the operation, the labor and equipments costs that may be associated with the operation, and desired profitability, taking into account any discounts that may apply. To determine a price for a desired well servicing treatment, the labor and equipment costs associated with the particular well servicing treatment should be taken into account. There are drawbacks to the current pricing methodologies. For example, current methodologies generally require a determination of the desired formulation of the treatment fluid prior to the determination of the price of the well servicing treatment. This may result in inaccuracies in the determined price and/or the use of formulations that are not the most desirable and/or cost-effective.

### SUMMARY

According to one aspect, the method comprises determining an internal factor of the oilfield operation representing a cost analysis of an oilfield service; determining an external factor of the oilfield operation representing a price analysis and/or a market analysis of the oilfield service; determining a price of the oilfield operation to be performed in the well for a customer, wherein the price is determined based on the internal factor and the external factor, and wherein determining the price comprises utilizing a data processing system; transmitting the price of the oilfield operation to the customer; completing a sale of the oilfield operation; and performing the oilfield operation in the well.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

Current embodiment relate to determining, pricing, and/or providing oilfield operation. The price of the oilfield operation may include pricing for chemicals, tools, labor, and/or equipment involved in the oilfield operation. The methods may be used for generating a price for a wide variety of oilfield operation that may be performed in oil, gas, geothermal, and/or water wells, such as drilling, completion, and workover operations. The drilling, completion, and workover operations may include, but are not limited to, drilling, fracturing, acidizing, logging, gravel packing, cementing, perforating, and conformance operations.

The methods of the present embodiments may be implemented utilizing any suitable data processing system, including computer systems, handheld devices, mobile phones, or any other suitable known device. In one embodiment, the data processing system may include a processor, a memory, and software operable on the processor to implement the methods of the present embodiments. A computer system suitable for use with the present embodiments comprises a processor, a memory, and an input output (“I/O”) interface. Processor may comprise one central processing unit, multiple processing units or may be distributed across one or more processors in one or more locations. In one embodiment, the memory is communicatively coupled to the processor. Memory may be read-only memory, random-access memory, or the like. In one embodiment, the I/O interfaces are communicatively coupled to the processor. I/O interfaces may be any suitable system for connecting computer system to a communication link, such as a direct connection, a private network, a virtual private network (“VPN”), a local area network (“LAN”), a wide area network (“WAN”), a wireless communication system, or combinations thereof; storage devices; external devices, such as a keyboard, a monitor, a printer, a voice recognition device, a mouse; or any other suitable system. A storage may also be provided. Storage should be communicatively coupled to at least one of the I/O interfaces. Storage may comprise any device suitable for storing data to be processed, including, but not limited to, compact disc drives, floppy drives, hard disks, and the like. Those of ordinary skill in the art will appreciate that suitable data processing systems may comprise additional, fewer, and/or different components than those described for computer system described herewith.

In one embodiment, to generate a price of a well servicing treatment utilizing the methods of the present embodiments, computer system is able to obtain and transmit data needed therefore. In one embodiment, the computer system may obtain data from and/or transmit data to a user via suitable I/O means. Suitable I/O means may be those already presented above. As used herein, “user” is defined to include real persons, data processing systems (e.g., computer systems, etc.), or any other suitable mechanism. The user may be associated with a provider of well servicing treatments or be a customer of such provider of well servicing treatments. In a second embodiment, computer system may obtain data from and/or transmit data to a user of a second computer system over a communication link. Communication link may be those already presented above. In a third embodiment, computer system may obtain data from and/or transmit data to a well site over a communication link. In these embodiments, data may be obtained from and/or transmitted to well site over any suitable communication link. One of ordinary skill in the art will recognize other suitable systems over which computer system may obtain and/or transmit data for a particular application.

Method of the present embodiments generally involves generating a price for an oilfield operation for a customer using an internal factor and an external factor of the oilfield operation in accordance with one embodiment. Method generally comprises determining an internal factor of the oilfield operation representing a cost analysis of an oilfield service; determining an external factor of the oilfield operation representing a price analysis and/or a market analysis of the oilfield service; determining a price of the oilfield operation to be performed in the well for a customer, wherein the price is determined based on the internal factor and the external factor, and wherein determining the price comprises utilizing a data processing system; transmitting the price of the oilfield operation to the customer; completing a sale of the oilfield operation; and performing the oilfield operation in the well.

An oilfield operation may be regarded as any type of operation performed by an oilfield service company. The oilfield operation may be regarded as one or multiple operations done through an oilfield service performed on a well. The oilfield service may include seismic acquisition, drilling, completion, wireline logging or measurement (MWD, LWD), mud logging, artificial lift operation, testing and workover operations. In one exemplary embodiment, the method applies to completion; the completion may include a cementing operation, a stimulation operation, a coil tubing operation and/or a sand management operation. In one exemplary embodiment, a well servicing treatment may be performed.

The well servicing treatment may include a stimulation operation. Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated,” for example using hydraulic fracturing, chemical (usually acid) stimulation, or a combination of the two (called acid fracturing or fracture acidizing). Hydraulic fracturing involves injecting fluids into a formation at high pressures and rates such that the reservoir rock fails and forms a fracture (or fracture network). Proppants are typically injected in fracturing fluids after the pad to hold the fracture(s) open after the pressures are released. In chemical (acid) stimulation treatments, flow capacity is improved by dissolving materials in the formation.

In hydraulic and acid fracturing, a first, viscous fluid called a “pad” is typically injected into the formation to initiate and propagate the fracture. This is followed by a second fluid that contains a proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped. Occasionally, hydraulic fracturing is done without a highly viscosified fluid (i.e., slick water) to minimize the damage caused by polymers or the cost of other viscosifiers.

When multiple hydrocarbon-bearing zones are stimulated by hydraulic fracturing or chemical stimulation, it is desirable to treat the multiple zones in multiple stages. In multiple zone fracturing, a first pay zone is fractured. Then, the fracturing fluid is diverted to the next stage to fracture the next pay zone. The process is repeated until all pay zones are fractured. Alternatively, several pay zones may be fractured at one time, if they are closely located with similar properties. Diversion may be achieved with various techniques including formation of a temporary plug using polymer gels or solid fluid loss materials.

Special equipment, labor, tool and chemistry are needed to perform those stimulation operations. Optimization of the equipment and labor used, and proper use of the tool and chemistry for each stages of the hydraulic fracturing will influence the cost of the operation. As well, the profitability of the well servicing operation is going to be dependent of various factors as disclosed herewith.

The well servicing treatment may include a cementing operation. After a well has been drilled and a casing put in the well-bore, subsequent cementing operations are generally undertaken to seal the annulus (i.e. the space between the well-bore and the casing where fluid can flow). A first operation may be primary cementing which purpose is to achieve hydraulic isolation around the casing. Other operations may be remedial cementing which purposes are to stabilize the well-bore, to seal a lost circulation zone, to set a plug in an existing well or to plug a well so that it may be abandoned. The cement may be pumped into the well casing through a casing shoe near the bottom of the bore-hole or a cementing valve installed in the casing so that the cement is positioned in the desired zone.

Cementing engineers prepare the cementing operations by determining the volume and physical properties of cement slurry and other fluids pumped before and after the cement slurry. In many situations, various chemical additives may be used in the cementing operations. Cement additives may be broadly categorized as accelerators (i.e. for reducing the time required for the set cement to develop sufficient compressive strength to enable further operations to be carried out), retarders (i.e. for increasing the thickening time of cement slurries to enable proper placement), dispersants (i.e. for reducing the cement slurry viscosity to improve fluid-flow characteristics), extenders (i.e. for decreasing the density or increasing the yield of a cement slurry), weighting agents (i.e. for increasing or lightening the slurry weight), fluid-loss or lost-circulation additives (i.e. for controlling the loss of fluid to the formation through filtration) and special additives designed for specific operating conditions.

Special equipment, labor, tool and chemistry are needed to perform those cementing operations. Optimization of the equipment and labor used, and proper use of the tool and chemistry for each type of cementing will influence the cost of the operation. As well, the profitability of the well servicing operation is going to be dependent of various factors as disclosed herewith.

The well servicing treatment may include a sand control operation. After a well has been drilled, cased and cemented, another operation may be involved: the sand control. The sand control completion involves the downhole construction of a two-stage filter for purposes of preventing unconsolidated materials coming from the formation from being produced with the oil or gas. The filter typically includes gravel pack sand (the outer stage) and a screen or liner (the inner stage). The gravel pack sand is sized according to the particle size distribution of the unconsolidated materials, and the screen or liner has openings that are sized to retain the gravel pack sand. The gravel pack sand retains the unconsolidated formation materials, and the screen liner retains the gravel pack sand. The produced oil or gas flows through the gravel pack sand, through the screen or liner and then typically into a production tubing string that communicates the fluid to the surface of the well. The gravel pack sand typically is deposited around the screen or liner in a “sand control” operation.

As well, special equipment, labor, tool and chemistry are needed to perform those sand control operations. Optimization of the equipment and labor used, and proper use of the tool and chemistry for each phases of the sand control completion will influence the cost of the operation. As well, the profitability of the well servicing operation is going to be dependent of various factors as disclosed herewith.

The well servicing treatment may include a coiled tubing operation. During the completion of the well, or during life of the life, it is often necessary or desirable to use coiled tubing operation. Coiled tubing is known to be useful to perform a variety of services including extend the life of the well, improve production, access a subterranean zone, or remedy a condition that has occurred during operations. Coiled tubing is particularly useful for well treatments involving fluids, with one or more fluids being pumped into the wellbore through the hollow core of coiled tubing or down the annulus between the coiled tubing and the wellbore. Such treatments may include circulating the well, cleaning fill, stimulating the reservoir, removing scale, fracturing, isolating zones, etc. The coiled tubing permits placement of those fluids at a particular depth in a wellbore. Coiled tubing may also be used to intervene in a wellbore to permit, for example, fishing for lost equipment or placement or manipulation of equipment in the wellbore. In deploying coiled tubing under pressure into a wellbore, the continuous length of coiled tubing passes through from the reel through wellhead seals and into the wellbore. Fluid flow through coiled tubing also may be used to provide hydraulic power to a toolstring attached to the end of the coiled tubing. A typical toolstring may include one or more non-return valves so that if the tubing breaks, the non-return valves close and prevent escape of well fluids.

As well, special equipment, labor, tool and chemistry are needed to perform those coiled tubing operations. Optimization of the equipment and labor used, and proper use of the tool and chemistry for each phases of the coiled tubing operation will influence the cost of the operation. As well, the profitability of the well servicing operation is going to be dependent of various factors as disclosed herewith.

When determining an internal factor of the oilfield operation, the internal factor will be linked to the cost analysis of the oilfield service. According to one embodiment, the oilfield operation is a hydraulic fracturing and the oilfield service is a pressure pumping activity. According to a second embodiment, the oilfield operation is a cementing operation and the oilfield service is a cementing pumping activity. According to a third embodiment, the oilfield operation is a sand control operation and the oilfield service is a sand management activity. The internal factor may be regarded as a cost analysis for a well characteristic, as a cost analysis for an available labor on the well site, and/or as a cost analysis for an equipment, a tool or a chemistry needed for the oilfield operation or available on the well site. The internal factor may be regarded as combination of multiple internal factors having each a different or same weight. The cost analysis will be performed considering fixed costs and variable costs.

The cost analysis for a well characteristic will be performed by considering a selected well characteristic or group of well characteristics and defining which one should be taken into account in the cost consideration of the oilfield service. The well characteristic may include a variety of routinely measurable or calculable parameters inherent in or desirable for a well for a particular treatment, including, but not limited to, bottom-hole static temperature (“BHST”), bottom-hole circulating temperature (“BHCT”), applicable environmental regulations, type of formation, type of hydrocarbons, geographical area, formation porosity, formation permeability, in-situ stress distribution, reservoir fluid viscosity, skin factor, reservoir pressure, reservoir depth, desired pump rate, etc. . . . . The well characteristics may be obtained using a variety of techniques.

The cost analysis for an available labor on the well site will be performed by considering which parameter representing labor should be taken into account in the cost consideration of the oilfield service. This parameter may include number of persons present on the well site, number of persons present in a district area near the well site, number of persons having a certain level of experience and/or training, service crew day or hour, people day or hour utilization.

The cost analysis for an equipment, a tool or a chemistry needed for the oilfield operation or available on the well site will be performed by considering which parameter should be taken into account in the cost consideration of the oilfield service. This parameter may include the equipment usage day or hour, e.g. pump utilization day or hour, horse power day or hour, the frac pump continuity, service job per stage, the chemistry used per day or hour, the maintenance schedule of the equipment, and/or the reparation schedule of the equipment.

In one aspect, the equipment used may include a frac pump unit, a well service pump, a sand delivery unit, a mobile blending unit, a frac water heater unit. In other aspects, the equipment may include a cement mixer, a cement bulk trailer, cementing trailer, a cementing truck. In another aspect the equipment may include a coiled tubing rig including an injector system, an injector supports, and a coiled tubing reel assembly on a reel stand.

In one aspect, the chemistry used may include a fracturing fluid with a viscosifying agent and optionally proppant. According to some embodiments, the viscosifying agent may be a polysaccharide such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds. According to some embodiments, the viscosifying agent may be a synthetic polymer such as polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof. According to some embodiments, the viscosifying agent may be a cellulose derivative such as hydroxyethylcellulose (HEC) or hydroxypropylcellulose (HPC), carboxymethylhydroxyethylcellulose (CMHEC) and carboxymethycellulose (CMC).

According to some embodiments, the viscosifying agent may be a biopolymer such as xanthan, diutan, and scleroglucan. According to some embodiments, the viscosifying agent may be a viscoelastic surfactant (VES). The VES may be selected from the group consisting of cationic, anionic, zwitterionic, amphoteric, nonionic and combinations thereof.

The fracturing fluid contain optionally a proppant such as high strength ceramics, sintered bauxite, and sand, all as is well known in the art

The fracturing fluid may additionally contain other materials (additives) such as additional additives, including, but not limited to, acids, fluid loss control additives, gas, corrosion inhibitors, scale inhibitors, catalysts, clay control agents, biocides, friction reducers, breakers, combinations thereof and the like.

When determining an external factor of the oilfield operation, the external factor will be linked to the price analysis of the oilfield service and/or will be linked to the market analysis of the oilfield service. According to one embodiment, the oilfield operation is a hydraulic fracturing and the oilfield service is a pressure pumping activity. According to a further embodiment, the external factor comprises a qualitative factor to the customer and a market factor to the oilfield operation.

The qualitative factor may include segmentation identifier associated with the customer, a key performance indicator (KPI) associated with the customer or with the oilfield service. The segmentation identifier is associated with the customer and depends of the activity, the history, the worth, and/or the geographic dominance for said customer for the operation service. The segmentation identifier may be a weighted factor of various attributes as the activity, the history, the worth, and/or the geographic dominance. The KPI may be any type of parameters reflecting the critical factors associated with the customer or the oilfield service.

The market factor may include a price or market analysis to define the applicable contribution margin, a future pricing policy, a demand profile, an historical profile, a rig count, and/or a forecasting. The contribution margin is the marginal profit per unit sale for the customer.

According to the method of the present embodiments, a price of the oilfield operation is generated based on the one or more internal factor and external factor that were obtained. In some embodiments, the price may be generated by a data processing system, such as computer system described above capable of generating a price of the oilfield operation based on the one or more internal factor and external factor. Generating a price of the oilfield operation based on the one or more internal factor and external factor may be accomplished by any suitable methodology, taking into account, for example, known and/or determinable weights associated with each of the one or more internal factor and external factor. For example, historical data for a number of previous oilfield operations may be collected and analyzed. Once these historical data and/or profitability matrixes are collected and analyzed, a relationship may be determined between the internal factor and external factor from the previous oilfield operation and the overall price of the previous oilfield operations. In some embodiments, this relationship between the price of a oilfield operation and internal factor and external factor may be expressed as a mathematical algorithm, wherein determining the price of the oilfield operation may include utilization of the mathematical algorithm.

In some embodiments, the methods of the present embodiments further may comprise transmitting the price of the oilfield operation that was generated. In some embodiments, the price may be transmitted to the user by computer system. Once transmitted to the user, a determination may be made as to whether the transmitted price was accepted by the customer. In some embodiments, the customer may be the user. In other embodiments, the user may be associated with a provider of oilfield operation, wherein the user may have to transmit the price to the customer.

If the customer accepts the price that was transmitted thereto, in some embodiments, the method may further comprise completing a sale of the oilfield operation based on the price of the oilfield operation. Completing the sale of the oilfield operation may be accomplished by utilizing any suitable technique for completing the sale of a oilfield operation between a customer and a provider of oilfield services. In one embodiment, where the price of the oilfield operation is transmitted by a data processing system (such as computer system) to the user (e.g., a customer) of a second data processing system (such as second computer) over a WAN, e.g., an Internet-based communication system, an online purchasing technique may be used. Any suitable online purchasing technique may be used, including, but not limited to, expedited online purchasing techniques, wherein required data for completing the purchase is saved so the purchasing technique does not include a step of submitting data. One of ordinary skill in the art, with the benefit of this disclosure, will be able to select an appropriate technique for completing the sale of the oilfield operation for a particular application.

Once a price of a oilfield operation is determined, as discussed above, the method may further comprise performing the oilfield operation. The oilfield operation that may be performed may be any of a wide variety of oilfield operation that may be performed in oil, gas, geothermal, and/or water wells, such as drilling, completion, and workover operations. The drilling, completion, and workover operations may include, but are not limited to, drilling, fracturing, acidizing, logging, gravel packing, cementing, perforating, and conformance operations.

In some embodiments, it may next be determined whether an additional oilfield operation will be performed. Any suitable technique may be used to determine whether another oilfield operation will be performed. For example, a user may have the option of performing the methodology again to price the additional oilfield operation, wherein the user may be prompted for a response. If an additional oilfield operation is to be performed, the execution of the methodology for obtaining one or more well internal factor and external factor of the additional oilfield operation is repeated.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

What is claimed is:

1. A method, comprising:
a. determining an internal factor of an oilfield operation representing a cost analysis of the oilfield service;
b. determining an external factor of the oilfield operation representing a price analysis and/or a market analysis of the oilfield service;
c. determining a price of the oilfield operation to be performed in the well for a customer, wherein the price is determined based on the internal factor and the external factor, and wherein determining the price comprises utilizing a data processing system;
d. transmitting the price of the oilfield operation to the customer;
e. completing a sale of the oilfield operation; and
f. performing the oilfield operation in the well.

2. The method of claim 1, wherein the internal factor comprises cost analysis considering fixed costs and variable costs.

3. The method of claim 1, wherein the external factor comprises a qualitative factor to the customer and a market factor to the oilfield operation.

4. The method of claim 3, wherein the qualitative factor comprises a segmentation identifier attached to the customer.

5. The method of claim 1, wherein the step of determining an internal factor of the oilfield operation comprises utilizing a data processing system.

6. The method of claim 1, wherein the step of determining an external factor of the oilfield operation comprises utilizing a data processing system.

7. The method of claim 1, wherein the data processing system comprises at least one a computer system or a handheld device.

8. A method of performing an oilfield operation, comprising:
a. determining an internal factor of the oilfield operation representing a cost analysis of the treatment to realize;
b. determining an external factor of the oilfield operation representing a price analysis and/or a market analysis of the treatment;
c. determining a price of the oilfield operation to be performed in the well for a customer, wherein the price is determined based on the internal factor and the external factor, and wherein determining the price comprises utilizing a data processing system;
d. transmitting the price of the oilfield operation to the customer;
e. completing a sale of the oilfield operation;
f. performing the oilfield operation in the well; and
g. deciding if the treatment is finished or if another oilfield operation is needed and repeating steps (a) to (g) thereof.

9. The method of claim 8, wherein the external factor comprises a qualitative factor to the customer and a market factor to the oilfield operation.

10. The method of claim 9, wherein the qualitative factor comprises a segmentation identifier attached to the customer.

11. The method of claim 8, wherein the step of determining an internal factor of the oilfield operation comprises utilizing a data processing system.

12. The method of claim 8, wherein the step of determining an external factor of the oilfield operation comprises utilizing a data processing system.

13. The method of claim 8, wherein the data processing system comprises at least one of the following: a computer system or a handheld device.

14. The method of claim 8, wherein the oilfield operation is selected from the group consisting of: cementing operation, a stimulation operation, a coil tubing operation, a sand management operation, and a combination thereof.

15. A method applying performing an equipment activity servicing oilfield operation in a well, comprising:
a. determining an internal factor of the oilfield operation representing a cost analysis of the equipment activity servicing;
b. determining an external factor of the oilfield operation representing a price analysis and/or a market analysis of the equipment activity servicing;
c. determining a price of the oilfield operation to be performed in the well for a customer, wherein the price is determined based on the internal factor and the external factor, and wherein determining the price comprises utilizing a data processing system;
d. transmitting the price of the oilfield operation to the customer;
e. completing a sale of the oilfield operation; and
f. performing the oilfield operation in the well.

16. The method of claim 15, wherein the internal factor comprises a factor representing quantity of equipment assigned to the oilfield operation multiple by a time scale.

17. The method of claim 15, wherein the internal factor comprises a factor representing number of persons assigned to the oilfield operation multiple by a time scale.

18. The method of claim 15, wherein the external factor comprises a qualitative factor to the customer and a market factor to the oilfield operation.

19. The method of claim 18, wherein the qualitative factor comprises a segmentation identifier attached to the customer.

20. The method of claim 19, wherein the segmentation identifier is selected from the group of: activity, the history, the worth, the geographic dominance for said customer for the operation service, and a combination thereof.

21. The method of claim 15, wherein the oilfield operation is selected from the group consisting of: cementing operation, a stimulation operation, a coil tubing operation, a sand management operation, and a combination thereof.

22. The method of claim 15, wherein the equipment used in the equipment activity is selected from the group consisting of: fracturing equipment, cementing equipment, coiled tubing equipment, and a combination thereof.

23. The method of claim 15, further comprising performing another oilfield operation and repeating steps (a) to (f) thereof.
